(19) United States
(12) Patent Application Publication
(10) Pub. No.: US 2012/0173242 A1
(43) Pub. Date: Jul. 5, 2012

(54) SYSTEM AND METHOD FOR EXCHANGE OF SCRIBBLE DATA BETWEEN GSM DEVICES ALONG WITH VOICE

(75) Inventors: Manas SARKAR, Noida (IN); Arun Kumar, Noida (IN); Nivaz N, Noida (IN)

(73) Assignee: Samsung Electronics Co., Ltd., Suwon-si (KR)

(21) Appl. No.: 13/339,991

(22) Filed: Dec. 29, 2011

(30) Foreign Application Priority Data
Dec. 30, 2010 (IN) 4029/CHE/2010
Nov. 25, 2011 (KR) 10-2011-0124009

(51) Int. Cl. G10L 13/08

(52) U.S. Cl. 704/260

(57) ABSTRACT

A method for transferring scribble data along with voice includes connecting at least two electronic devices through a GSM network, accumulating and down sampling the scribble coordinates, which are converted to a speech-like signal that is sent along with voice data packets simultaneously in the GSM network.

### PRIORITY

This application claims priority under 35 U.S.C. §119(a) to an Indian patent application filed in the India Patent Office on Dec. 30, 2010 and assigned Serial No. 4029/CHE/2010 and a Korean Patent Application filed in the Korean Intellectual Property Office on Nov. 25, 2011 and assigned Serial No. 10-2011-0124009, the contents of which are incorporated herein by reference.

### BACKGROUND OF THE INVENTION

1. Field of the Invention

The present invention relates generally to mobile technology, and more particularly, to a mobile technology for simultaneously exchanging scribble data information with voice between Global System for Mobile Communication (GSM) devices.

2. Description of the Related Art

Conventional methods exist for simultaneously transmitting speech through an audio channel and video data over data channel by switching the audio channel to a data channel, after detecting a ‘gap period’ during a voice conversation between mobile users.

However, technology is not presently available for simultaneously sending voice along with any other non temporal, real time data through a GSM network. Methods are available for sending pictures and low bit rate video along with voice, but parallel data transmission may require re-transmission of the data part when an error occurs in the transmission/communication channel. Thus, such methods are not reasonable where a data sequence is relevant over time and is to be transferred in real time.

Although data may be sent along with voice exchange by way of Dual Transfer Mode (DTM)-enabled General Packet Radio Service (GPRS), Third Generation Partnership Project Wideband Code Division Multiple Access (WCDMA 3G), these services are generally unavailable and costly.

Therefore, the need exists in the art for an improved technology for transmitting scribble data transmission along with speech.

### SUMMARY OF THE INVENTION

Embodiments of the present invention provide a system and method for real time exchanging of speech along with scribble information between two mobile devices between which GSM connectivity is established.

According to an embodiment of the present invention, a system for transferring scribble data along with voice includes means for simultaneously transmitting handwriting along with speech on a voice call in a GSM network. A writing pad may appear on an electronic device or a mobile screen during a voice call, on which pad a user scribbles a message or data that is processed and sent to a receiver. The scribbled data is decoded and presented to a display application so as to instantly appear to the receiver's screen during the speech.

### BRIEF DESCRIPTION OF THE DRAWINGS

In the accompanying figures, similar reference numerals refer to identical or functionally similar elements. These reference numerals are used in the detailed description to illustrate embodiments and to explain various aspects and advantages of the present invention.

FIG. 1 illustrates a system for transferring a scribble data along with voice according to the present invention;

FIG. 2 illustrates an example of the scribble data to be transferred according to the present invention;

FIG. 3 illustrates a trapezoidal or a saw tooth wave form representation of the x coordinate of the data of points of the scribble data according to the present invention;

FIG. 4 illustrates a trapezoidal or a saw tooth wave form representation of the y coordinate of the data of points according to the present invention.

FIG. 5 illustrates an example of an interleaved speech and speech-like data packets according to the present invention;

FIG. 6 illustrates a method of transferring a scribble data along with voice for scribble data transmission and receiving operation sequence according to the present invention;

FIG. 7 illustrates an example of a transmitting device according to the present invention; and

FIG. 8 illustrates an example of a receiving device according to the present invention.

### DETAILED DESCRIPTION OF EMBODIMENTS OF THE INVENTION

Reference will be made to embodiments of the present invention with reference to the attached drawings. A detailed description of a generally known function and structure of the present invention will be omitted for the sake of clarity and conciseness.

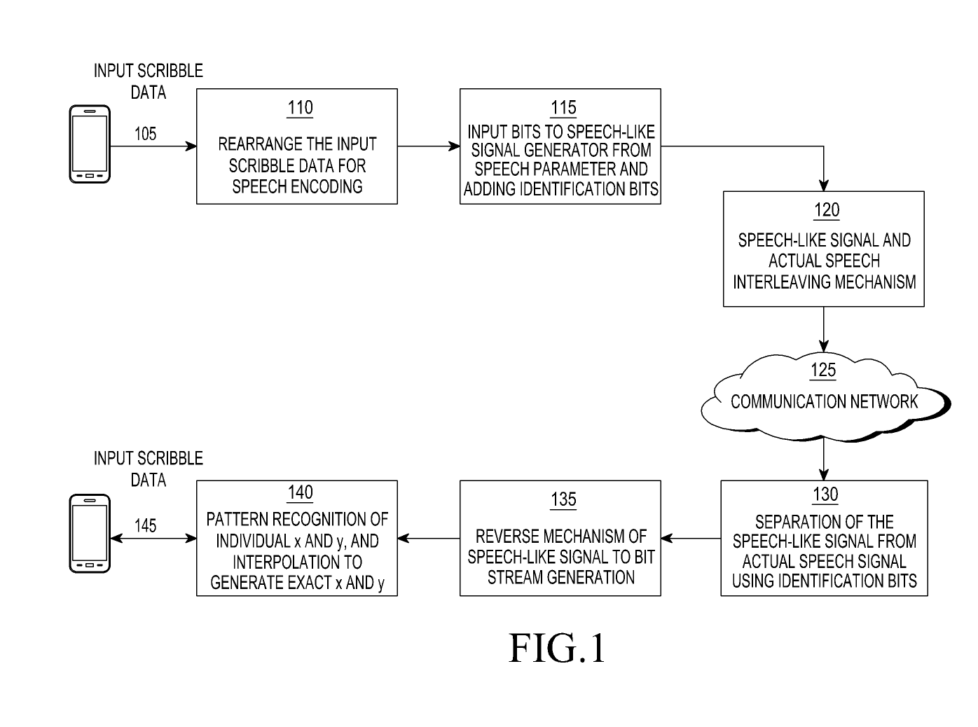

FIG. 1 illustrates a system for transferring scribble data along with voice according to the present invention.

The system of FIG. 1 relates to transmitting handwriting along with speech on a voice call in a GSM network. A writing pad such as a touch screen or a keypad is made to appear on a mobile screen or an electronic device during a voice call. The user may scribble a message or data on the touch screen or by keypad movement in the mobile phone or the electronic device. Herein, scribble data is any data input by a user on the touch screen or by keypad movement.

The scribble data may be transmitted as a voice packet(s). The relative x and y location of the scribbled data is separately accumulated and synthesized as a GSM speech- like signal. Any available method such as AutoRegressive (AR) modeling for speech production may be used to synthesize the GSM speech-like signal.

The synthetic speech that is generated according to the GSM technology is transmitted over the GSM network as speech transmission. The speech-like data packet may be transmitted interlaced with the actual speech signal to the GSM network. An identification bit is added in each Time Division Multiple Access (TDMA) packet in the speech-like GSM data packet to identify the scribble data.

The scribbled data input is encoded and processed before the scribbled data is transmitted to a receiver. At the receiver end, the scribble data is decoded and forwarded to the display unit to be instantly displayed on the receiver's screen. The scribble data is displayed simultaneously on the receiver's screen along with the shared speech.

At 105, the sender inputs scribble data on his/her mobile screen.

At 110, the input scribble data is re-arranged for speech encoding. Data is arranged in a suitable form to generate a speech-like signal by synthesis, by using a speech synthesis mechanism.

At 115, the scribble data segments are synthesized using existing speech synthesis mechanisms and the speech-like GSM signal is generated. The Identification bits are added at the beginning of each voice packet.

At 120, the speech-like signal is interleaved with an actual speech signal.

At 125, the GSM scribble data signal is transmitted to the communication network through the same channel used in the GSM voice communication.

At 130, the speech-like signal is separated from the actual speech signal at the receiver end by identifying the identification bits attached with the speech-like signal that was sent in each time sample burst.

At 135, the GSM signal is de-synthesized to generate the scribble data segments.

At 140, individual x and y data is separately collected as an x and y stream. Trapezoidal or Saw-tooth patterns are separately recognized after interpolation for the x and y data stream and the exact x and y data is generated.

At 145, after ensuring the optimal representation of the recovered data, the (x, y) points are formed and plotted over to generate the output scribble data at the receiving end.

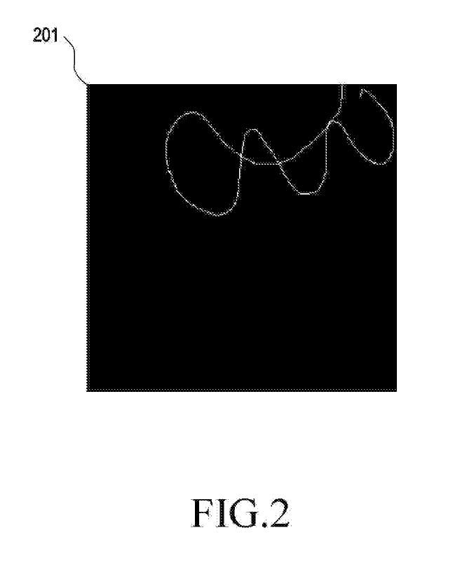

FIG. 2 illustrates an example of the scribble data to be transferred according to the present invention.

For example, FIG. 2 represents the scribbled data that can be drawn on the touch screen of the electronic device or any other data to be transmitted that is drawn from the pen.

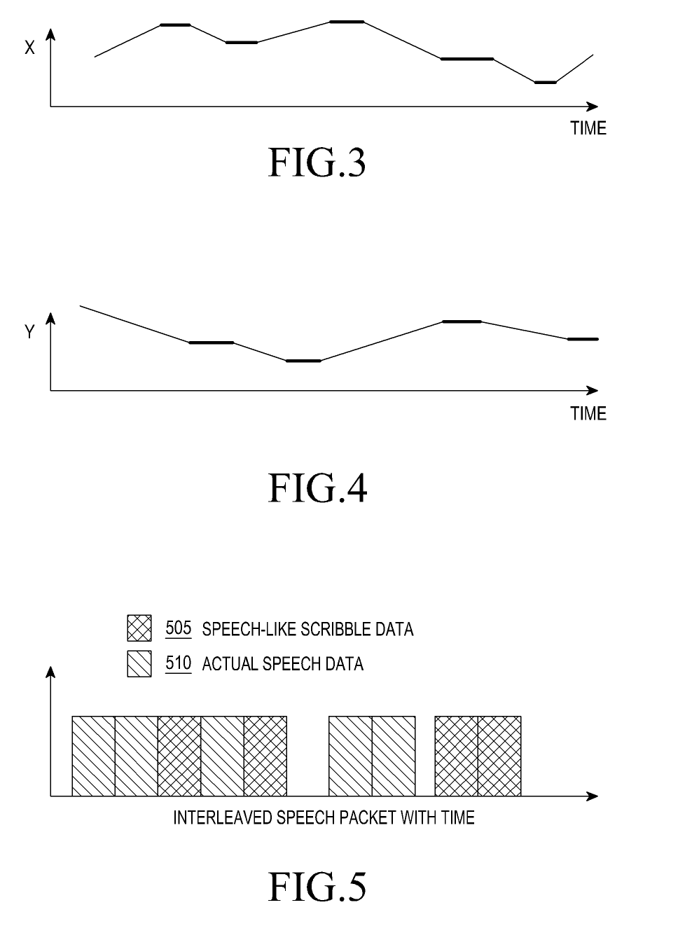

FIG. 3 illustrates a trapezoidal or a saw tooth wave form representation of the x coordinate of the data of points according to the present invention.

The x coordinate data is synthesized and sent after adding identification bits along with the speech signal. The speech converted x-coordinate data on reaching the other end is identified and de-synthesized to retrieve the scribbled x coordinate.

FIG. 4 illustrates a trapezoidal or a saw tooth waveform representation of the y coordinate of the data of points according to the present invention.

The y coordinate data is synthesized and sent after adding identification bits along with the speech signal. When the speech converted y-coordinate data reaches the other end, it is identified and de-synthesized to retrieve the scribbled y coordinate.

The data is represented in forms of trapezoidal or saw tooth waves in FIG. 3 and FIG. 4 so that it can be used as a strong reference while regenerating the x and y data. The data can be regenerated or corrected more accurately from the speech converted scribble data. Additionally, at no time is there any substantial change of either the x or y data. Thus, even after distortion of some of the values, the data can be fairly predicted by considering the few past or future values. Prediction can be done by some interpolation or by best fitting to straight line segments.

The ‘x’ and the ‘y’ scribble data are separately collected. After separate regeneration or correction of the x and the y data, the x and the y data are presented to the drawing layer to be plotted as the (x, y) coordinate and the input scribble data is then shown at the receiver end.

FIG. 5 illustrates an example of interleaved speech and speech-like data according to the present invention.

FIG. 5 illustrates a speech-like scribble data 505 and actual speech data 510. The speech-like scribble data 505 is interleaved with the actual speech data 510 and is transmitted through the same transmission channel used by the actual speech data 510 along with the voice packets. The speech-like scribble data 505 is received at the receiver end and is identified by using the identification tags (not shown) attached thereto. The speech-like scribble data 505 is then separated from the actual speech data 510 and is de-synthesized to obtain the original scribble data.

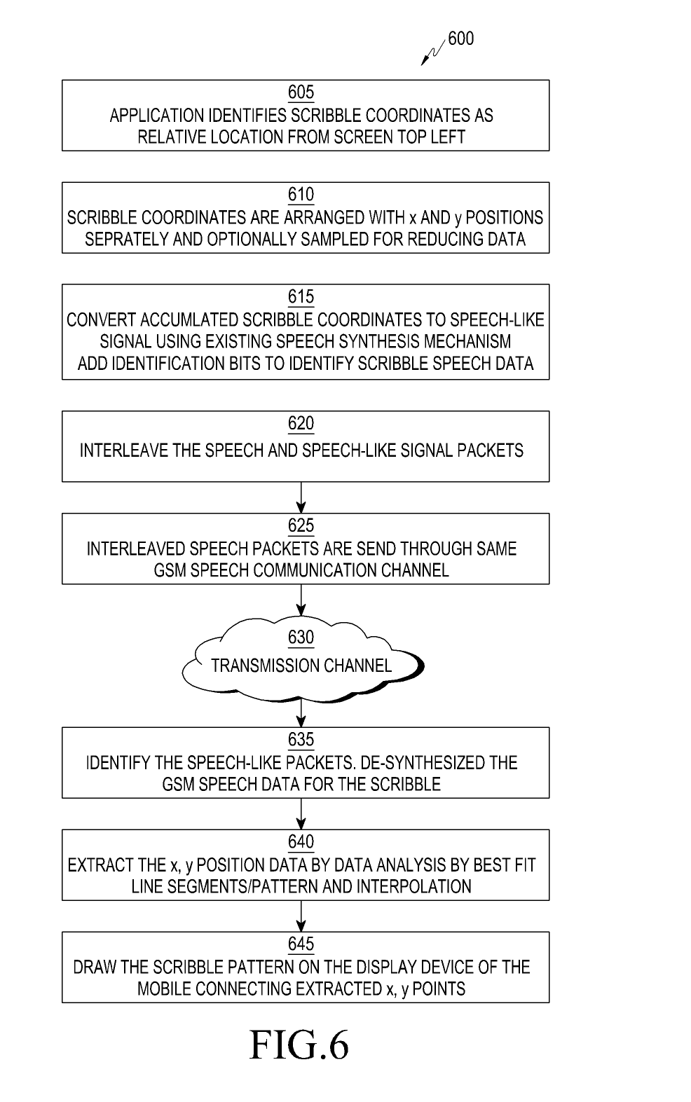

FIG. 6 illustrates a method of transferring a scribble data along with voice for scribble data transmission and receiving operation sequence according to the present invention.

At step 605, the application identifies the scribble coordinates as the relative location from a top left location 201 of the screen.

At step 610, the scribble coordinates are separately arranged with the x and the y positions and are optionally sampled for reducing the data.

At step 615, the accumulated scribble coordinates are converted to a speech-like signal by using an existing speech synthesis mechanism. Identification bits are added to the speech-like signal for identifying the scribble speech data.

At step 620, the speech-like scribble data is interleaved with the actual speech data in the form of speech voice packets.

At step 625, the interleaved speech (voice) data packets are sent through the same GSM speech communication or transmission channel as used by the actual speech signals.

At step 630, the interleaved data is transmitted through the GSM communication or transmission channel.

At step 635, the interleaved speech-like packets are identified by identifying the attached identification bits. The GSM speech data is then de-synthesized for obtaining the actual scribble data.

At step 640, the x and the y position data is extracted by data analysis using best-fit line segments or pattern matching and interpolation.

At step 645, the scribble pattern is drawn on the display device of the receiver's mobile phone or any other electronic device by connecting the extracted x and y points.

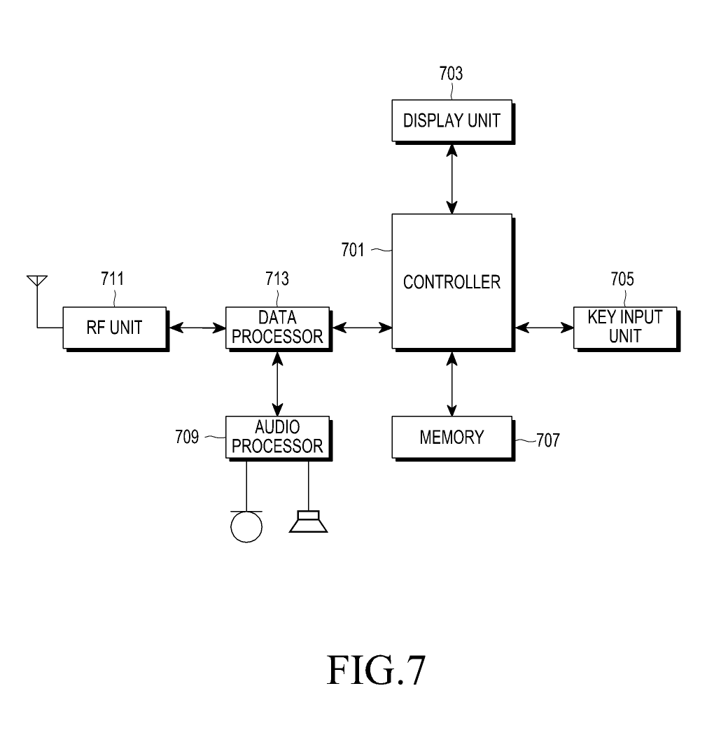

FIG. 7 illustrates a transmitting portable terminal according to an embodiment of the present invention.

Referring to FIG. 7, the transmitting portable terminal includes a controller 701, a display unit 703, a key input unit 705, a memory 707, an audio processor 709, a Radio Frequency (RF) unit 711 and a data processor 713.

The RF unit 711 performs a wireless communication function of the transmitting portable terminal. More specifically, the RF unit 711 includes a wireless transmitter for up-converting and low noise amplifying a frequency of a transmitted signal, and a wireless receiver for low noise amplifying a received signal and down-converting a frequency. The data processor 713 includes a transmitter (not shown) for encoding and modulating a transmitted signal, and a receiver (not shown) for decoding and demodulating a received signal. The data processor 713 may include a modem (not shown) and a codec (not shown), and the codec may include a data codec for processing packet data and an audio codec for processing an audio signal such as voice.

The audio processor 709 performs a function of reproducing a reception audio signal output from the data processor 713 through a speaker or transmitting a transmission audio signal generated from a microphone to the data processor 713. The key input unit 705 includes keys for inputting number information and character information and function keys for setting various functions, and the display unit 703 displays both an image signal on a screen and data requested to be output from the controller 701.

When the display unit 703 is implemented in a touch display screen manner such as a capacitive or a resistive type screen, the key input unit 705 may include only a minimum of preset keys, and the display unit 703 may replace a part of key input functions of the key input unit 705. Particularly, the display unit 703 receives scribble data from a user during a voice communication and outputs the received scribble data to the controller 701. The display unit 703 can receive an input of scribble data generated by a user's finger or a stylus pen.

The memory 707 includes a program memory and a data memory. The program memory stores a booting and an Operating System (OS) for controlling a general operation of the transmitting portable terminal, and the data memory stores data generated during the operation of the portable terminal.

The controller 701 controls the general operation of the transmitting portable terminal. Particularly, the controller 701 transmits scribble data for exchanging information with the other user as voice packet(s).

More specifically, the controller 701 separates the relative x and y location of the scribble data to store the separated relative x and y location in the memory 707, and generates the stored relative x and y location as the GSM speech-like signal. The controller 701 can use a method such as an AR modeling for generating voice to generate the GSM speech-like signal.

The controller 701 transmits the GSM speech-like signal over the GSM network by using a voice transmitting method. More specifically, the controller 701 synthesizes the speech signal and the GSM speech-like signal to generate a synthesized speech signal and transmits the generated synthesized speech signal over the GSM network. The controller 701 adds an identification bit to the GSM speech-like signal in order to indicate that the GSM speech-like signal includes the scribble data. For example, the controller 701 can add the identification bit in each TDMA packet in the GSM speech-like data packet.

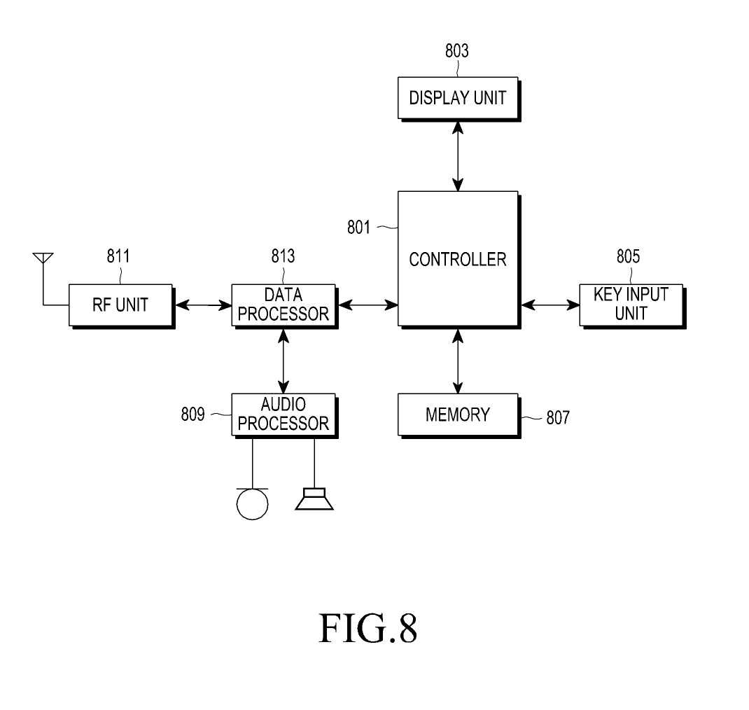

FIG. 8 illustrates a receiving portable terminal according to an embodiment of the present invention.

Referring to FIG. 8, the receiving portable terminal includes a controller 801, a display unit 803, a key input unit 805, a memory 807, an audio processor 809, an RF unit 811, and a data processor 813.

The RF unit 811 performs a wireless communication function of the receiving portable terminal. More specifically, the RF unit 811 includes a wireless transmitter (not shown) for up-converting and low noise amplifying a frequency of a transmitted signal, and a wireless receiver (not shown) for low noise amplifying a received signal and down-converting a frequency. The data processor 813 includes a transmitter (not shown) for encoding and modulating a transmitted signal, and a receiver (not shown) for decoding and demodulating a received signal. The data processor 813 may include a modem (not shown) and a codec (not shown), and the codec may include a data codec for processing packet data and an audio codec for processing an audio signal such as voice.

The audio processor 809 performs a function of reproducing a reception audio signal output from the data processor 813 through a speaker or transmitting a transmission audio signal generated from a microphone to the data processor 813. The key input unit 805 includes keys for inputting number information and character information and function keys for setting various functions, and the display unit 803 displays an image signal on a screen and displays data requested to be output from the controller 801.

When the display unit 803 is implemented in a touch display screen manner such as a capacitive or a resistive type screen, the key input unit 805 may include only a minimum of preset keys, and the display unit 803 may replace a part of key input functions of the key input unit 805. Particularly, the display unit 803 displays the scribble data output from the controller 801.

The memory 807 includes a program memory and a data memory. The program memory stores a booting and an operating system for controlling a general operation of the receiving portable terminal, and the data memory stores data generated during the operation of the receiving portable terminal.

The controller 801 controls the general operation of the receiving portable terminal. Particularly, the controller 801 displays scribble data received from the transmitting portable terminal during a voice communication in the display unit 803.

The controller 801 receives a synthesized speech signal from the transmitting portable terminal during the voice communication, and identifies the identification bit added to the GSM speech-like signal to de-synthesize the synthesized speech signal into the GSM speech-like signal and the speech signal.

The controller 801 decodes the GSM speech-like signal to generate the relative x and y location of the scribble data, and displays the scribble data based on the relative x and y location generated in the display unit 803.

Advantages of the foregoing system and method are that two users can simultaneously talk and scribble at the cost of a normal voice call. Moreover, any typical mobile phone or any other electronic device including a touch pen may support the scribble feature, as a typical screen may be able to plot the scribble data in real time.

In the preceding description, the present invention and its advantages have been described with reference to specific embodiments. However, it will be apparent to a person of ordinary skill in the art that various modifications and changes can be made, without departing from the scope of the present disclosure, as set forth in the claims below. Accordingly, the specification and figures are to be regarded as illustrative examples of the present disclosure, rather than restrictive. All such possible modifications are intended to be included within the scope of the present disclosure.

What is claimed is:

1. A system for exchanging scribble data information between electronic devices, the system comprising:
a transmitting electronic device for capturing scribble data, converting the scribble data to a speech-like signal, interleaving the speech-like signal with a speech signal, and transmitting the interleaved signal to a receiving electronic device, the transmitting electronic device having an interface for scribbling an input; and
the receiving electronic device for receiving the interleaved signal, extracting a speech-like signal from the interleaved signal, decoding the extracted speech-like signal to generate scribble data packets, and displaying the scribble data packet,
wherein the scribble data is sent simultaneously with the speech signal in real time.

2. The system as claimed in claim 1, wherein the transmitting and receiving electronic devices refer to mobile phones or electronic devices performing GSM (Global System for Mobile) communications.

3. The system as claimed in claim 1, wherein the transmitting electronic device inserts identification bits to the speech-like signal for interleaving with an actual speech signal.

4. The system as claimed in claim 1, wherein the scribble data is received simultaneously with voice in a receiving mobile phone or the receiving electronic device.

5. A method of transmitting scribble data between transmitting and receiving electronic devices, the method comprising:
identifying scribble coordinates of scribble data on the transmitting electronic device;
sampling the scribble coordinates;
synthesizing segments of the scribble data to generate a speech-like signal;
inserting identification bits in the speech-like signal;
interleaving the speech-like signal with an actual speech signal; and
transmitting the interleaved signal to the receiving electronic device through a channel for voice communication.

6. The method as claimed in claim 5, wherein a stream of the scribble data is represented by coordinates x and y, has one of a trapezoidal or a saw tooth waveform, and is synthesized to a speech-like signal.

7. The method as claimed in claim 6, wherein the identification bits are inserted at the beginning of the speech-like signal.

8. A method of receiving scribble data between electronic devices, the method comprising:
receiving a speech signal from a transmitting electronic device;
identifying identification bits from the received speech signal to identify speech-like packets;
separating the identified speech-like packets to extract scribble data;
extracting and interpolating x and y position data for the scribble data; and
displaying the interpolated x and y position data on a display unit of a receiving electronic device.

9. The method as claimed in claim 8, wherein the scribble data is received simultaneously with voice in real time in an electronic device for GSM (Global System for Mobile) communications.

10. An apparatus for transmitting scribble data between electronic devices, the apparatus comprising:
a display unit; and
a controller for receiving scribble data from the display unit, identifying scribble coordinates of the scribble data, sampling the scribble coordinates, synthesizing segments of the scribble data to generate a speech-like signal, inserting identification bits in the speech-like signal, interleaving the speech-like signal with an actual speech signal, and transmitting the interleaved signal through a channel for voice communication.

11. The apparatus as claimed in claim 10, wherein a stream of the scribble data is represented by coordinates x and y, has one of a trapezoidal or a saw tooth waveform, and is generated as a speech-like GSM (Global System for Mobile) signal.

12. The apparatus as claimed in claim 11, wherein the identification bits are inserted at the beginning of the speech-like signal.

13. An apparatus for receiving scribble data between electronic devices, the apparatus comprising:
a display unit; and
a controller for receiving a speech signal from a transmitting electronic device, identifying identification bits from the received speech signal to identify speech-like packets, separating the identified speech-like packets to extract scribble data, extracting and interpolating x and y position data for the scribble data, and displaying the interpolated x and y position data on the display unit.

14. The apparatus as claimed in claim 13, wherein the scribble data is received simultaneously with voice in real time in an electronic device for GSM (Global System for Mobile) communications.
